(19) United States
(12) Patent Application Publication
(10) Pub. No.: US 2013/0226535 A1
(43) Pub. Date: Aug. 29, 2013

(54) CONCURRENT SIMULATION SYSTEM USING GRAPHIC PROCESSING UNITS (GPU) AND METHOD THEREOF

(71) Applicant: Jeh-Fu Tuan, San Jose, CA (US)

(72) Inventor: Jeh-Fu Tuan, San Jose, CA (US)

(21) Appl. No.: 13/405,062

(22) Filed: Feb. 24, 2012

(51) Int. Cl. G06F 17/50; G06F 17/11

(52) U.S. Cl. 703/2; 703/14

(57) ABSTRACT

A concurrent circuit simulation system simulate analog and mixed mode circuit using by exploiting parallel execution in one or more graphic processing units. In one implementation, the concurrent circuit simulation system includes a general purpose central processing unit (CPU), a main memory, simulation software and one or more graphic processing units (GPUs). Each GPU may contain hundreds of processor cores and several GPUs can be used together to provide thousands of processor cores. Software running on the CPU partitions the computation tasks into tens of thousands of smaller units and invoke the process threads in the GPU to carry out the computation tasks.

### BACKGROUND OF THE INVENTION

1. Field of the Invention

The present invention relates to a concurrent simulation system for analog and mixed mode circuits using a central processing unit (CPU) and one or more graphic processing units (GPUs). This invention is particularly suitable for repeated simulations of the same or similar circuits under the same or different operating conditions (e.g., circuit characterization, circuit optimization, and Monte Carlo simulation).

2. Discussion of the Related Art

Analog, mixed signal, memory and system-on-a-chip (SOC) markets are the fastest growing market segments in the semiconductor industry. In particular, an SOC integrated circuit integrates both digital and analog functions onto a single semiconductor substrate. The SOC approach is particularly favored in hand-held and mobile applications, which are characterized by high integration, high performance and low power. In the design process of an SOC integrated circuit, designing the included analog and mixed signal circuits is the bottleneck.

Analog and mixed signal circuits are typically custom designs requiring verification by circuit simulation software, such as the SPICE simulator. However, circuit simulation is a time-consuming process. Furthermore, there has not been any significant advancement in either analog circuit design techniques or circuit simulation techniques over the past 30 years. The custom design process is an iterative process of verification and re-design cycles of circuit verification and optimization. Because circuit simulations are slow, a typical analog and mixed mode circuit design process either takes too long or results in an integrated circuit that is not fully verified or optimized before being released to manufacturing. The result is missed market opportunities, non-functional circuit, or yield losses. In the meantime, a designer of circuit simulation software faces the challenges of increasing circuit sizes, increasing complexity in device model equations, increasing number of parasitic elements, and increasing demands for more Monte Carlo simulation runs to accommodate greater process variations. Therefore, improvements in circuit simulation speed and designer productivity have become important issues faced by the circuit design community.

In recent years, GPUs, which are designed to accelerate graphics applications, have become highly parallel processors capable of hundreds of Gflops/sec¹. Competition among the GPU vendors for market share in the PC gaming market has driven technological advancements in graphics cards, and the sales volume of such graphics cards has driven prices down. These GPUs can be applied to non-graphical high-performance computing (HPC) applications. GPUs have been used in a number of areas outside of graphic cards with success, thus creating new markets for the main graphics card vendors, e.g., Nvidia and AMD/ATI. Therefore, the companies have introduced product lines that specifically target HPC applications, which are sometimes referred to as the general purpose GPU (GPGPU) market. The latest GPU offering from Nvidia is called “Fermi,” which has many new features addressing the GPGPU market. ¹ Gflop/sec is a measure of processor performance, representing an instruction execution rate of a billion floating point instructions per second.

A typical GPU has an SIMD (single-instruction multiple data) architecture, which exploits data level parallelism. The typical GPGPU application uses both a CPU and a GPU, constituting a heterogeneous co-processing computing model. The sequential part of the application is typically run on the CPU, while the computationally-intensive part, but which can be made parallel, is accelerated by the GPU. From the user's perspective, the application runs faster because of the high-performance GPU.

In the past few years, many successes have been achieved using the “compute unified device architecture” (CUDA) parallel programming model. CUDA is a parallel computing architecture developed by Nvidia. CUDA makes the computing engines in Nvidia's GPU accessible to software developers through programming language interfaces that are modified from industry standard programming languages. In CUDA, the application developer modifies his/her application to map compute-intensive kernels to run on the GPUs, while the remainder of the application runs on the CPU. Mapping a function to run on the GPU involves rewriting the function to expose the parallelism in the function. The developer is tasked with launching tens of thousands of threads simultaneously, allowing the GPU hardware to manage and to schedule the threads.

Once compiled, kernels consist of many threads that execute the same program in parallel. Multiple threads are grouped into thread blocks. All of the threads in a thread block run on a single streaming multiprocessor (SM) in which threads cooperate and share memory. Thread blocks coordinate the use of a global shared memory among themselves but may execute in any order, i.e., concurrently or sequentially. Thread blocks are divided into warps of 32 threads. A warp is the fundamental unit of dispatch within a single SM. In Fermi, two warps from different thread blocks (even different kernels) can be issued and executed concurrently, thereby increasing hardware utilization and energy efficiency. Thread blocks are grouped into grids, each of which executes a unique kernel. Thread blocks and threads each have identifiers (IDs) that relate them to the kernel. These IDs are used within each thread as indexes to their respective input and output data, shared memory locations and other resources and data.

In general, GPGPU technology has been successfully applied to the following fields: supercomputer clusters, physics, audio processing, image processing, video processing, weather forecast, molecular modeling, computational finance, medical imaging, digital signal processing, electronic design automation (EDA) and other applications. For example, GPGPU technology has been used by the EDA(Electronic Design Automation) industry to provide performance. However, although some EDA applications showed good results (e.g., Optical Proximity Correction (OPC)), most EDA applications do not accelerate at all. This is because most EDA applications are graph-based, which is fundamentally different from the parallel algorithms that run on the GPU in computer graphic applications. Thus, in EDA applications, the speed-up achievable by a GPU depends heavily on the nature of the application.

Circuit simulation is an EDA application that can be accelerated by GPU. This is because, in circuit simulation, a majority of the CPU time is spent in model evaluation and matrix solution. According to Amdahl's law, the speed-up achievable by a program using multiple processors in parallel is limited by the fraction of the time the program spends in executing its sequential portion. In order to achieve maximum speed-up, both model evaluation and matrix solution have to be sped up significantly. If only one of the two activities is sped up, only a 3-4 times overall speed-up (relative to execution by a single CPU) can be achieved. Device model evaluation can be parallelized efficiently, For example, over speed up by 30 times in model evaluation have been reported, which offers an overall speed-up of three. Circuit simulation often involves solving a sparse matrix² using a direct method (e.g., LU factorization). Sparse matrix solutions cannot achieve the maximum speed-up with a GPU because of its irregular memory access pattern. Besides numerical computation, a conventional matrix solution also requires such operations as finding ordering, non-zero patterns and pivoting. Such operations are typically graph-based algorithms, which are not efficiently executed in a GPU. Such inefficiency limits the overall speed-up achievable in a conventional sparse matrix solution. Hence, it also limits the overall speed-up for the circuit simulation. Even for a circuit simulator that uses either a special matrix solver or a public domain GPU solver, such as OpenCL, significant inefficiency still exists. ² A sparse matrix is a matrix in which a majority of the elements are zero. A sparse matrix is often represented by one or more index arrays which are used to point to a value array storing the values of the non-zero matrix elements.

Another factor that affects performance is memory access. In a conventional circuit simulator using a GPU, all data structures are typically stored in the CPU memory, which are transferred from the CPU memory to the GPU memory for numerical computation. Results from the numerical computation are then transferred back to the CPU memory for further processing. Data transfers between the CPU memory and the GPU memory are slow relative to the GPU computational throughput. The problem is aggravated at large circuit sizes. Therefore, in a circuit simulation application, frequent data transfers between the CPU memory and the GPU memory can significantly reduce the overall speed-up achievable in the GPU. Therefore, while a circuit simulation program executed on both a CPU and a GPU can offer significant speed-up over a circuit simulation program executed on a single CPU, there is little significant advantage when compared to a circuit simulation programs using a multi-threading algorithm that runs on a multi-processor.

As mentioned above, circuit simulation programs face challenges in increasing circuit size, more complex device model equations, more parasitic elements, and greater number of simulation runs that are required because of more complex process variations (e.g., using Monte Carlo simulation techniques). For example, during a custom circuit design process, the verification, optimization and characterization steps require simulating the same or similar circuits many times. The circuits are often small-to-medium size “IPs”³ or function blocks. During the initial phase of the design process, a designer runs many simulations in the design space to search for a functional design. The designer then proceeds to optimize the design through many simulations to make sure the circuit performs optimally under many different operating conditions and process corners. With increased process variations, it is sometimes necessary to run these simulations using the Monte Carlo simulation technique, which requires tens of thousands of simulations of the same circuit, each with a different set of process variations. Further circuit simulations are performed for verification and optimization after the circuit layout is done. During the post-layout phase, parasitic resistor, capacitor and inductor elements are modeled to allow accurate estimation of circuit performance. Notably, the post-layout netlist can often be tens to hundred of times larger than the pre-layout netlist. As a result, a post-layout circuit simulation takes significantly more time than a pre-layout simulation. Once post-layout simulations are done, most custom designed blocks are characterized for functionality, timing, power and other characteristics with post-layout netlist. Only after the characteristics are found acceptable that the circuit may be integrated with other circuits onto the silicon substrate (e.g., in an SOC). The characterization process also requires simulating the same circuit under many different operating conditions and process corners. Traditionally, the circuit optimization, Monte Carlo simulation and circuit characterization processes are performed using circuit simulation software that requires a large number of computational resources and software licenses. Since many designers do not have access to unlimited computational resources and software licenses, these design tasks are also the most time-consuming in the custom circuit design process. ³ An IP, which stands for “intellectual property” is a circuit block that is designed by—and licensed from—a third party.

U.S. Pat. No. 7,979,814, entitled “Model implementation on GPU,” discloses using four-texture data to perform model evaluation in a GPU. The four-texture data are connected by multiple links. The model evaluation is carried out in multiple threads using the linked. U.S. Patent Application Publication 20100318593, entitled “Method for Using a Graphics Processing Unit for Accelerated Iterative and Direct Solutions to Systems of Linear Equations,” discloses a way to solve linear equations using iterative or direct methods using GPU. Other uses of GPUs are disclosed in (a) U.S. Patent Application 20110035736, entitled “GRAPHICAL PROCESSING UNIT (GPU) ARRAYS,” and (b) U.S. Patent Application 20110252411, entitled “IDENTIFICATION AND TRANSLATION OF PROGRAM CODE EXECUTABLE BY A GRAPHICAL PROCESSING UNIT (GPU).

### SUMMARY

According to one embodiment of the present invention, a concurrent simulation system for analog and mixed mode circuits includes a general purpose processor, a main memory storing simulation software, an input device, an output device. and one or more graphic processing units each including locally accessible memory. An interconnection bus may be provided to connect the general purpose processor to the graphic processing units. The simulation software is executable by the general purpose processor to control the input device, the output device and to program operations in the graphic processing unit for circuit simulation. In addition, the graphic processing unit includes numerous processors capable of executing in multiple process threads in parallel. Such process threads may be used to simulate the same circuit under different operating conditions, or under different device parameter values. Some fixed parameter values may be provided in the locally accessible memory to be accessed by multiple process threads simultaneously. Such fixed parameter values may include, for example, device model parameters. Other fixed parameter values may include values used in solving matrix equations, such as fixed ordering, predefined non-zero patterns, and fixed pivoting arrays.

In one embodiment, accessing by the process threads to data values may be sped up for maximum throughput bandwidth by suitably assigning data to locations of consecutive addresses to allow memory coalescing. Such speed-up is particularly beneficial to applications such as circuit characterization, circuit optimization, and Monte Carlo simulations.

Therefore, the present invention provides a concurrent circuit simulation system using one or more GPUs to speed-up the multiple circuit simulations needed in a custom circuit design process. Applications such as circuit optimization, circuit characterization, and Monte Carlo simulation can be significantly sped up using the concurrent circuit simulation system. In a concurrent simulation, the circuit simulation system duplicates the base circuit many times and simulates it under different operating conditions, process variations, and input/output (I/O) parameters. Such concurrent simulations may number in tens of thousands.

For circuit optimization, the concurrent simulation system duplicates each simulated circuit and applies to each duplicated circuit a different set of design parameter values (e.g. device sizes). The concurrent simulation system may also apply to each simulated circuit a different set of process conditions (e.g.., temperature). The concurrent simulation system runs various simulations simultaneously. The optimization program analyzes the results and continues the process until a set of optimal design parameter values is found that satisfies the design performance specifications.

For circuit characterization, the concurrent simulation system duplicates a base circuit and applies to each duplicated circuit a different set of input/output conditions, operating conditions, and process corners. The concurrent simulation system runs the various simulations simultaneously. Thereafter, a characterization program extracts the values of the performance parameters (e.g., circuit timing and power).

For Monte Carlo simulations, the concurrent simulation system duplicates the simulated circuits using different process variations, according to parameter values obtained from either device models or designer inputs. The concurrent simulation system runs various simulations concurrently and analyzes the results to extract statistical information. The concurrent simulation system also supports other circuit simulation applications that require repeated simulations. The concurrent simulation system can handle one or more base circuits simultaneously.

In general, in a circuit simulation application, most of a CPU's run time is spent in model evaluation and matrix solution. Thus, to achieve the highest overall speed-up, the speed-up algorithm controls throughput in both device model evaluation and matrix solution. GPU computational performance is related to memory bandwidth, which depends, in turn, on the memory access pattern. A random memory access can take several hundred GPU clock cycles, thus resulting in a very low memory bandwidth. There are several memory addressing patterns which allows a GPU to access memory more efficiently. When all process threads in the same block access the same memory address, the data can reside within either the texture memory or the constant memory. Both the texture memory and the constant memory are read-only data and may be cached, so that data can be accessed within two clock cycles. Size and use limits may be imposed on both the in texture memory and the constant memory. For example, data in the constant memory may be used only for constant values or pre-calculated data. The remaining data may be stored in the GPU's global memory, which may be accessed more efficiently under a memory coalescing access arrangement (i.e., when consecutive process threads access locations of consecutive memory addresses). Although the texture memory and the constant memory can also be accessed more efficiently than the global memory, the texture memory and the constant memory are read-only and limited in size. Shared memory within the GPU processors are also very efficient, but they are limited to being accessed locally and their use may require modification and careful tuning of the software program.

Likewise, model evaluation can be structured and formulated to take advantage of the GPU architecture. In one circuit simulation program, all circuit element data structures are stored by device types. In that circuit simulation program, each device model evaluation is launched as a process thread in the GPU. All model parameters are stored in the texture memory or the constant memory of the GPU, and all device specific data stored in global memory locations of contiguous addresses in the GPU. Under such an arrangement, the consecutive process threads in the GPU access either the same texture or constant memory locations or consecutive global memory locations at the same time, thus achieving the highest memory bandwidth within the GPU and the highest computation throughput.

Rather than using a general graph-based matrix solution technique (e.g., LU decomposition), which typically requires symbolic factorization for ordering, numerical factorization for finding non-zero patterns, and pivoting, the concurrent simulation system uses a fixed ordering scheme. In a fixed ordering scheme, ordering is determined in advance via a trial matrix solution. Once ordering is fixed, the non-zero patterns are also fixed. Pivoting may then be used to help maintain numerical accuracy, A fixed pivoting scheme is effective for small-to-medium size matrices, using double precision arithmetic. In a concurrent simulation, each matrix is launched as a separate process thread in the GPU. The ordering, non-zero patterns and pivoting information are stored in the texture memory or the constant memory in GPU and the numerical data of each matrix is stored in consecutive memory locations. In such an arrangement, consecutive process threads access the same location in the texture memory or the constant memory, or global memory locations of contiguous addresses in the GPU, thereby achieving the highest memory bandwidth within GPU and highest computation throughput.

Unlike the conventional approach, in which circuit simulation data structures are maintained in the CPU, and are transferred to and from the GPU when invoked, the concurrent simulation system stores simulation data structures in the GPU. Data transfers between the CPU and the GPU are carried out only for input or output purposes. Since none of circuit optimization, circuit characterization or Monte Carlo simulation operations require a large amount of data output, the concurrent simulation system is very efficient for such applications.

In one embodiment, system I/O operations are handled by the CPU, some device models or functions that cannot easily be ported to the GPU are also handled by the CPU. Therefore, unlike the conventional use of GPU circuit simulations, such simulation data generated by the CPU are transferred to the GPU for combination with data already in the GPU.

Accordingly, the present invention provides a concurrent simulation system for performance enhancement, which includes a processor, a memory, simulation software, an input device, an output device and a GPU. The concurrent simulation system is specifically designed to handle in a custom circuit design repeated simulation operations, such as common in circuit optimization, circuit characterization, and Monte Carlo simulations. Special algorithms and data structures are devised to take full advantage of the GPU architecture and simulation data storage mainly in the GPU, so as to reduce data transfer overhead costs.

The present invention is better understood upon consideration of the detailed description below in conjunction with the accompanying drawings.

### BRIEF DESCRIPTION OF THE DRAWINGS

FIG. 1 is a block diagram illustrating concurrent simulation system 100, in accordance with one embodiment of the present invention.

FIG. 2 is an architecture suitable for implementing a concurrent simulation system of the present invention, having one or more stream processors (SM), each including multiple processor cores and registers, a shared memory and a constant memory.

FIGS. 3A and 3B illustrate the required pairing of process threads and data locations to achieve a coalesced memory access arrangement, according to one embodiment of the present invention.

FIG. 4 shows the data structures suitable for use in a model evaluation step of a concurrent simulation, in accordance with one embodiment of the present invention.

FIG. 5 shows the data structures suitable for use in a matrix solution step of a concurrent simulation, in accordance with one embodiment of the present invention.

FIG. 6 shows the manner in which data structures, such as those shown in FIGS. 5 and 6 are transferred between CPU memory (e.g., CPU memory 602) and GPU memory 601, in accordance with one embodiment of the present invention.

FIG. 7 shows a circuit optimization flow using a concurrent simulation system of the present invention.

FIG. 8, shows a circuit characterization flow using a concurrent simulation system of the present invention.

FIG. 9 shows a Monte Carlo simulation flow using a concurrent simulation system of the present invention.

FIG. 10 shows an alternative embodiment of the invention where the CPU and GPU reside within the same SOC and share the same global memory

### DESCRIPTION OF THE PREFERRED EMBODIMENTS OF THE INVENTION

Reference is now made in detail to the preferred embodiments of the present invention. While the present invention is described in conjunction with the preferred embodiments, such preferred embodiments are not intended to be limiting the present invention. On the contrary, the present invention is intended to cover alternatives, modifications and equivalents within the scope of the present invention, as defined in the accompanying claims.

In the following detailed description, merely for exemplary purposes, the present invention is described based on an implementation using the Nvidia CUDA programming environment, which is executed on Nvidia Fermi GPU hardware.

According to one embodiment of the present invention, a concurrent simulation of a custom designed circuit is carried out by the following algorithm:
(a) providing as input to the concurrent simulation system circuit netlist, device models, operating condition, and circuit input and output signals;
(b) building data structures for the input circuit in the CPU memory;
(c) providing a pre-solved matrix solution to obtain matrix ordering, non-zero patterns and pivoting information;
(d) duplicating and copying circuit simulation data structures to the GPU based on the application and the input specifications, including::
   (i) for a circuit optimization application, duplicating and copying into each data structure a different set of design parameter values (e.g., device sizes) or a different set of operating conditions;
   (ii) for Monte Carlo simulations, generating all the statistically varied values for all random variables and duplicating circuit data structure each with a different set of random variable values or operating conditions; and
   (iii) for circuit characterization, duplicating and copying into each data structure a different input/output conditions, temperatures and process corners, using more than one base circuits, which can be simultaneously generated;
(e) performing circuit simulation in the GPU;
(f) copying simulations output values from the GPU to the CPU and copying simulation data from the CPU to the GPU for tasks that cannot be handled by the GPU;
(g) analyzing in the CPU the results during or after circuit simulation; and
(h) when the simulation task is too large to be handled by the GPU at once at step (e), dividing the task into smaller blocks and submitting each task to the GPU in multiple steps according to step (e).

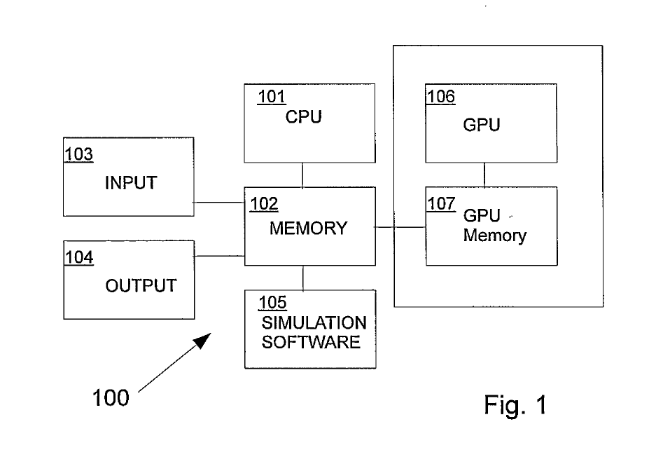

FIG. 1 is a block diagram illustrating concurrent simulation system 100 which includes CPU or general purpose processor 101, CPU memory 102, input subsystem 103, output subsystem 104, simulation software 105 stored in a program memory that is accessible by CPU 101, GPU or graphic processing unit 106 and GPU memory 107. GPU 106 includes numerous processor cores cooperating in executing numerous processor threads, which may be organized into groups, such as warps. Concurrent simulation system 100 is controlled by simulation software 105. Simulation software 105 may carry out the concurrent simulation algorithm described above. When a user specifies a circuit to be simulated, executing simulation software 105 on processor 101 results in simulation data being generated in memory 102. The simulation data is then duplicated and modified based on the specific application and user specifications. The duplicated and modified data is then copied to GPU memory 107 for performance of simulation in GPU 106. Executable code for the simulation in GPU 106 is also copied into GPU memory 107. After simulation, the results are copied form GPU memory 107 to CPU memory 102. Simulation software 105 then causes the results to be analyzed by CPU 101. The analyzed results and reports generated by the analysis are sent to output subsystem 104 for display or to be otherwise reported. In one embodiment, GPU memory 107 may include a texture memory, a constant memory, one or more shared memory units and a global memory. The texture memory and the constant memory are optimized for read-only data. Each block of threads may be allocated a shared memory unit that is accessible only by that block of threads. The global memory is typically much larger than the texture memory and the constant memory. The texture memory, the constant memory and the global memory are generally accessible by all the process threads. One or more level of caching may be provided in GPU memory 107.

CPU 101 and GPU 106 may be integrated into a single integrated circuit (e.g., fabricated on the same semiconductor substrate). In such an architecture, i.e., the SOC approach, communication between CPU 101 and GPU 106 may be carried out using one or more internal processor bus systems or through one or more shared register or memory systems. One advantage of such a system is a faster communication between CPU 101 and GPU 106. For example, data transfer between the CPU and GPU memories over external memory buses is eliminated, thus providing better performance. In some embodiments, GPU memory 107 may be provided on-chip. Alternatively, CPU memory 102 and GPU memory 107 may be implemented in the same external memory system. Because the desired memory bandwidth requirements between CPU 101 and GPU 106 may be different, the SOC may have separate memory buses for CPU 101 and GPU 106. The techniques described herein achieves high utilization of memory bandwidth for GPU 106 in such a system and corresponding high system performance.

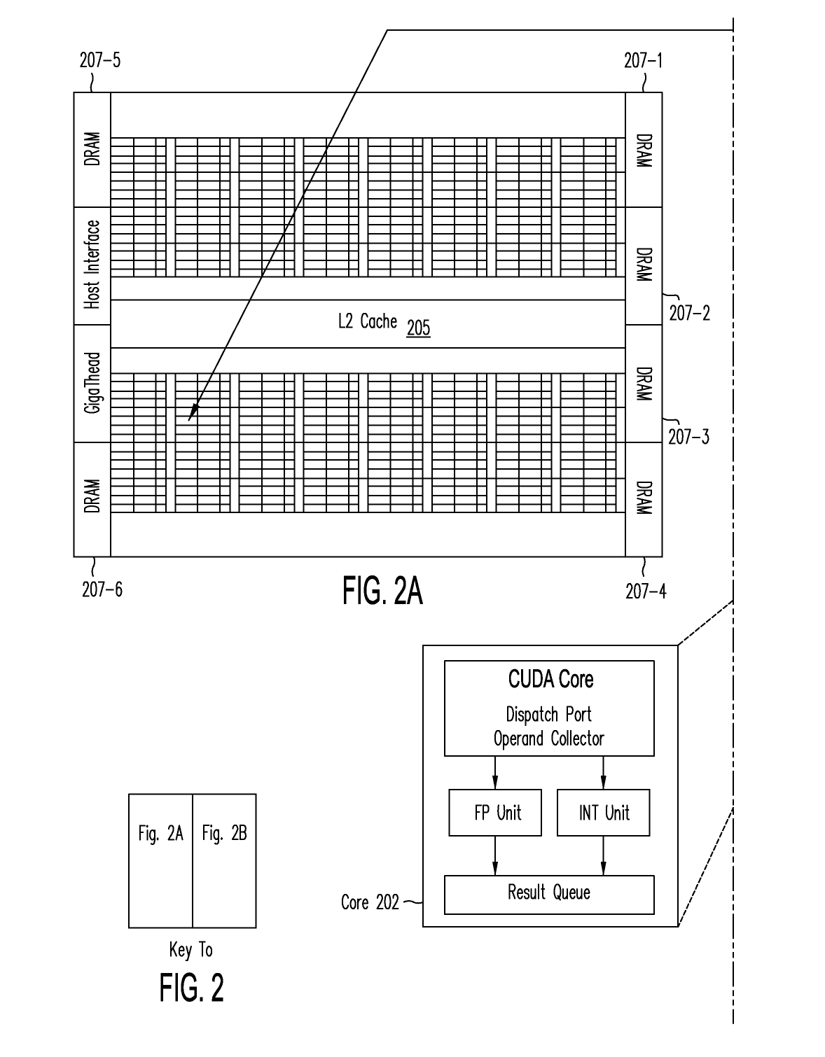

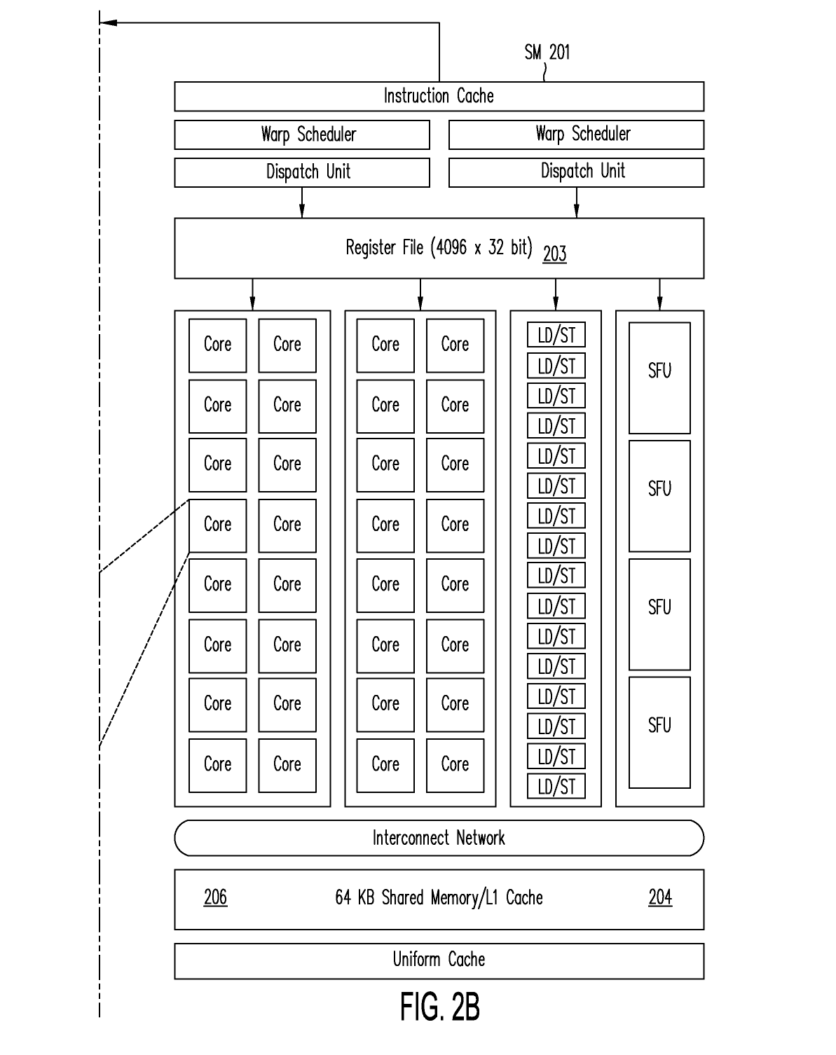

FIG. 2 shows GPU architecture 200 that is suitable for implementing the concurrent simulation system of the present invention. GPU 200 may be, for example, a GPU having the Nvidia Fermi architecture. As shown in FIG. 2, GPU architecture 200 includes an integrated circuit having 16 streaming multiprocessors (e.g., streaming multiprocessor (SM) 201), second-level or “L2” cache 206, and six on-chip dynamic random access memory (DRAM) controllers 207-1 to 207-6 (collectively, “DRAM controllers 207”) for accessing a global memory shared by all the SMs. DRAM controllers 207 may be, for example, configured to access a 64-bit wide memory. Each streaming processor includes 32 processor cores (e.g., processor core 202), register file 203, which includes 4096 32-bit registers, 64K-byte of memory divided between shared memory 206 and first-level (i.e., “L1”) cache 204, and control circuitry including an instruction cache, warp schedulers and dispatch units. In one implementation, the 64K-byte memory may be divided into either as a 16K-byte shared memory 206 and 48K-byte cache. Alternatively, the 64-Kbyte memory may be divided into 48K-byte of shared memory and 16-Kbyte of L1 cache. 768K-byte second-level (i.e., “L2”) cache 205 is provided to back-up the L1 caches of the streaming processors. L2 cache 205 may be fully coherent across the integrated circuit, supporting all 16 SMs. Memory accesses to DRAM 207 may go through L2 cache 205; DRAM 207 is accessed in the event of a cache miss in L2 cache 205. L2 cache 205 is particularly helpful when threads from multiple SMs are accessing the same data, in which case L2 cache 205 can serve the requested data without accessing DRAM controllers 207, thereby amplifying significantly the bandwidth available in architecture 200. In this embodiment, the entire memory hierarchy (i.e., from the register file 203 to L1 cache 204, L2 cache 205 to the six 64-bit memory controllers 207), is protected by using error correction codes (ECC). Robust ECC support is needed for the GPGPU and the HPC applications.

Each processor core (e.g., processor core 202) of architecture 200 includes an instruction dispatch port (for receiving an issued instruction), an operand collector, floating point (FP) and integer (INT) execution units and a result output port. In total, there are 512 processor cores in architecture 200.

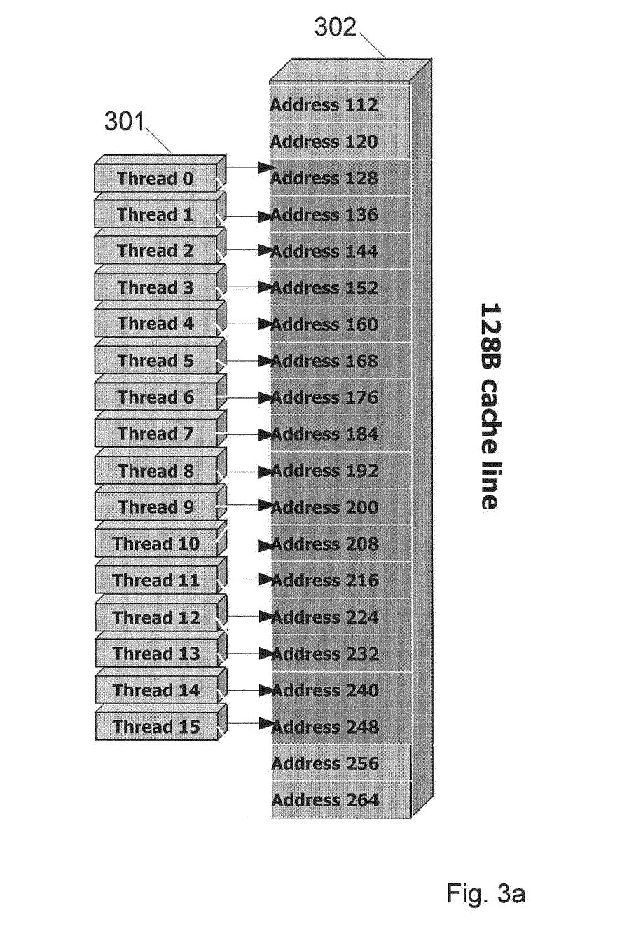

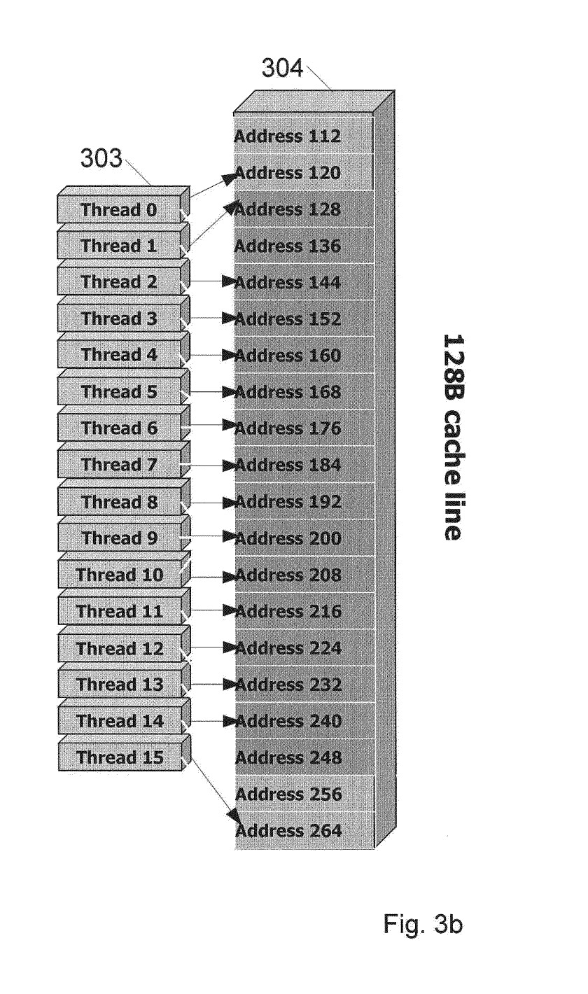

Significant speed-up in circuit simulation can be achieved using “memory coalescing.” FIG. 3A and FIG. 3b together illustrate pairings of process threads and GPU global memory addresses for two different memory access patterns; the memory access pattern of FIG. 3A satisfies the requirements for memory coalescing, while the memory access pattern of FIG. 3B does not satisfy the memory coalescing requirements.

FIG. 3A and FIG. 3B each show 16 threads in a thread block (TB) numbered consecutively and gathered sequentially into warps. In this embodiment, e.g. implemented by the Nvidia Fermi GPU, a group of 32 threads form a warp. Each warp executes in SIMD (single-instruction, multiple-data) fashion, i.e. all threads in the same warp execute the same instruction simultaneously. When the threads of a half-warp (16 threads) execute a global load, the loads are consolidated if they meet constraints necessary for the hardware to perform memory coalescing. Otherwise the loads are serviced individually. In general, memory coalescing occurs when the following four requirements on memory accesses to the global memory are met: (a) each element of the array has 4, 8, or 16 bytes and are aligned; (b) the threads in the half-warp accesses consecutive memory addresses in order (i.e., thread number N within the half-warp accesses address BaseAddr+N); (c) thread numbering matters only along the first dimension of the thread block; and (d) BaseAddr must be aligned to a multiple of the element size*half warp size (i.e., aligned to the beginning of a segment). In different embodiments with different GPUs, memory coalescing can be achieved using different constraints or under different requirements.

As shown in FIG. 3A, 16 threads in half-warp 301 access 16 consecutive element addresses in global memory 302, beginning with thread 0 accessing address 128, thread 1 accessing address 136, . . . , thread 15 accesses address 248. (In this embodiment, each element in this instance is 8 bytes.) In FIG. 3A, the threads access consecutive element memory addresses, beginning at base address 128, which is a multiple of 8 (i.e., aligned to segment boundary). Thus, the memory access pattern satisfy memory coalescing, it only requires one memory transaction to read/write the data.

In contrast FIG. 3B, 16 threads in half-warp 303 access 16 addresses in global memory 304, with thread 0 accessing address 120, thread 1 accessing address 128, thread 2 accessing address 144, . . . , thread 14 accessing address 240, thread 15 accessing address 264. The memory access pattern does not satisfy memory coalescing, it requires more than one memory transactions to read/write the data.

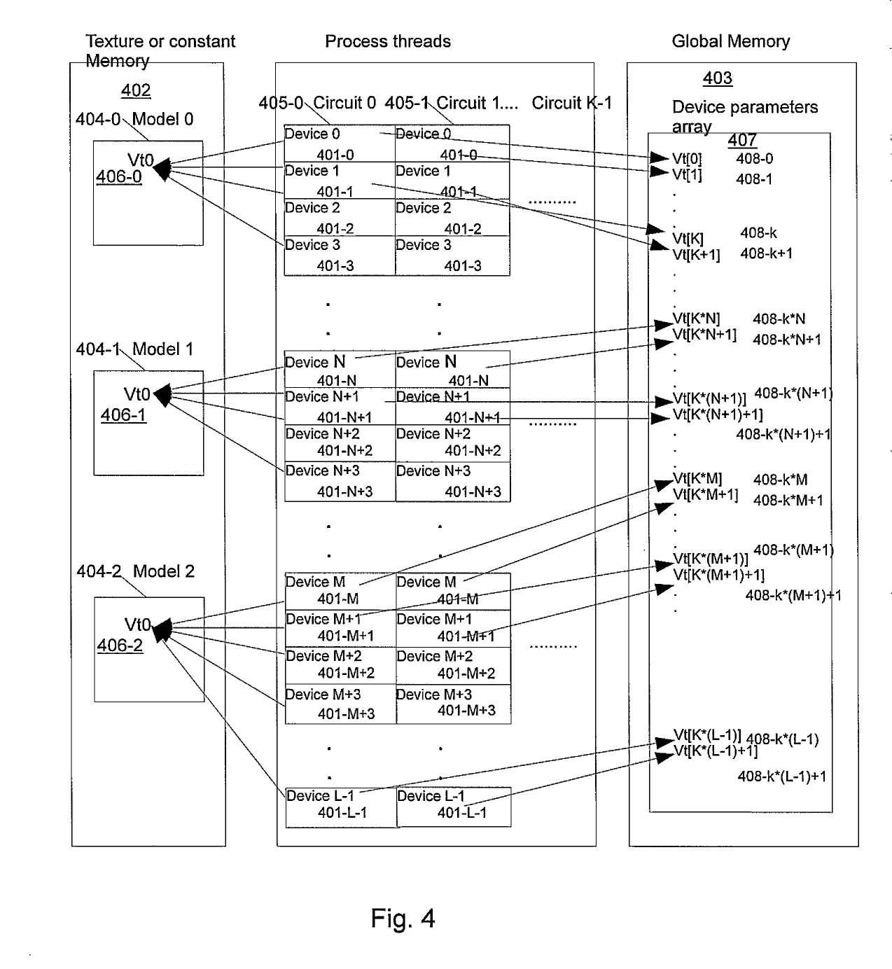

FIG. 4 shows the data structures suitable for use in a model evaluation step of a concurrent circuit simulation, in accordance with one embodiment of the present invention. In FIG. 4, the concurrent circuit simulation involves K duplicated circuits of M+4 devices each, and 3 device models. In FIG. 4, the duplicated circuits are numbered 0, . . . , K−1, the devices are numbered 0 to L−1, and the device models are numbered 0 to 2. Device models 0 to 2 are stored in texture or constant memory 402. Device parameter arrays 407 are stored in global memory 403. For each parameter, an array for that parameter is indexed by circuit index and device index. For example, for device parameter array Vt, element Vt[0] corresponds to the first duplicated circuit (i.e., duplicated circuit 0) and the first device (i.e., device 0). Element Vt[1] corresponds to the second duplicated circuit (i.e., duplicated circuit 1) and the first device (i.e., device 0). Element Vt[K] corresponds to the first duplicated circuit (i.e., duplicated circuit 0) and the second device (i.e., device 1). Element Vt[L*K−1] is the last element. A device data structure array is indexed by device number. As shown in FIG. 4, for example, devices 0 to 3 are mapped to model 0. Similarly, devices N to N+3 are mapped to device model 2, and devices M to M+3 are mapped in device model 3.

Each device of each duplicated circuit launches a corresponding process thread (i.e., a total of K*L process threads would be launched). There are two ways to order the process threads: either “device number index major” or “duplicated circuit index major”. Under device number index major, the first L process threads correspond to devices 0 to L−1 of duplicated circuit 0, the next L process threads correspond devices 0 to L−1 of duplicated circuit 1, etc. Under duplicated circuit index major, the first K process threads correspond to device 0 of duplicated circuits 0 to K−1, the second K process threads correspond to device 1 of duplicated circuits 0 to K−1, etc. Since the number of duplicated circuits are expected to be more than the number of devices in each circuit, the process threads are preferably ordered according to duplicated circuit index major. For example, an inverter circuit has one NMOS and one PMOS device, and it can be duplicated 10s of 1000s of times in the concurrent simulation. If the circuit is duplicated 1,024 times, the number 1,024 is in multiples of 16 thus aligns memory boundary and therefore satisfies the requirements for memory coalescing. Under duplicated circuit index major, the first 1,024 process threads correspond to the NMOS device and the second 1,024 process threads correspond to the PMOS device.

Under duplicated circuit index major, each K process threads correspond to the same device in K duplicated circuits. Thus, the same device model is accessed by the K process threads. The values in the device parameter arrays are (a) values that are pre-calculated before model evaluation, (b) runtime values calculated during device model evaluation, or (c) values to be returned to the simulation program. As discussed above, each device parameter has an array which stores the values of that parameter for all the devices in all of the duplicated circuits. Under the memory coalescing scheme discussed above, with proper selection of K, memory coalescing can provide maximum memory bandwidth, thus achieving maximum computational throughput.

The models and devices shown in FIG. 4 may be, for example, metal-oxide semiconductor (MOS) models and devices. Similar data structures can also used for other device types, such as bipolar junction transistor (BJT), diode, resistor, capacitor and others.

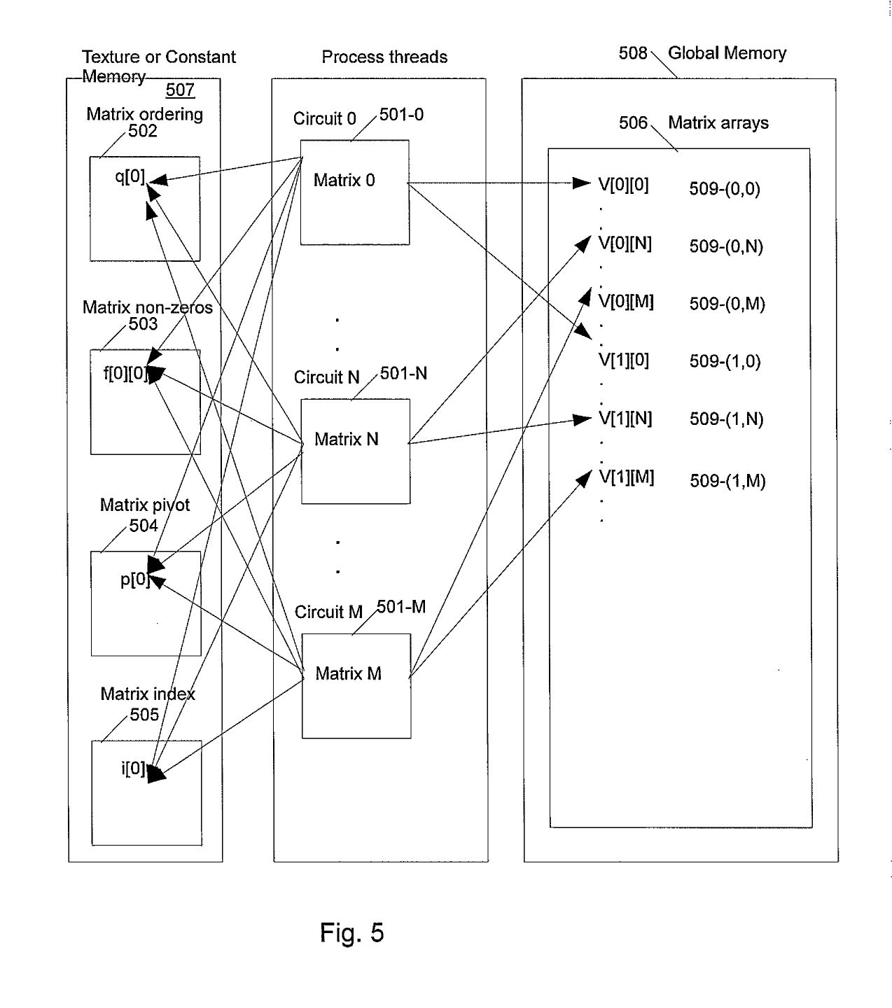

FIG. 5 shows the data structures suitable for use in a matrix solution step of a concurrent simulation, in accordance with one embodiment of the present invention. As shown in FIG. 5, one-dimensional matrix ordering array 502, 2-dimensional non-zero pattern array 503, one-dimensional pivoting array 504, and one-dimensional sparse matrix index array 505 are provided in memory 507, which may be the texture memory or the constant memory. In addition, matrix arrays 506, which includes the numerical values of the elements in the original matrix, expressed as 2-dimensional upper (U) and lower (L) matrices, are stored in global memory 508. Matrices 0-M represents the duplicated circuits, each corresponding to a specific set of parameter values, are each launched as a process thread. All process threads accesses matrix ordering array 502, non-zero pattern array 503, pivoting array 504 and sparse matrix index array 505 simultaneously.

Memory coalescing may be used also for accessing matrices in global memory 508. For example, voltage matrix V[x][y], representing the voltages at nodes [x=0, . . . , P] of circuits [y=0, . . . , M], may be provided at locations of consecutive addresses, such that process threads 0, . . . , M, each representing a simulation of the duplicated circuits 0, . . . , M can access the voltage nodes x at the same time. Provided that the conditions for memory coalescing are satisfied, access to matrix V[x][y] for each node x be carried out in a single read transaction. In other words, voltages V[0]]0], V[0][1], . . . , V[0, M], corresponding to the voltages at node 0 computed in duplicated circuits 0, . . . , M, are accessed in one memory transaction in one coalesced memory transaction. The two dimensional array is stored as a one dimensional array (e.g., in circuit number major fashion, i.e., V[0][0], V[0][1], . . . , V[0][M], V[1][0], . . . , V[P][M]). with the elements assigned in order to locations of consecutive addresses. This addressing scheme achieves maximum memory bandwidth thus achieve maximum computation throughput.

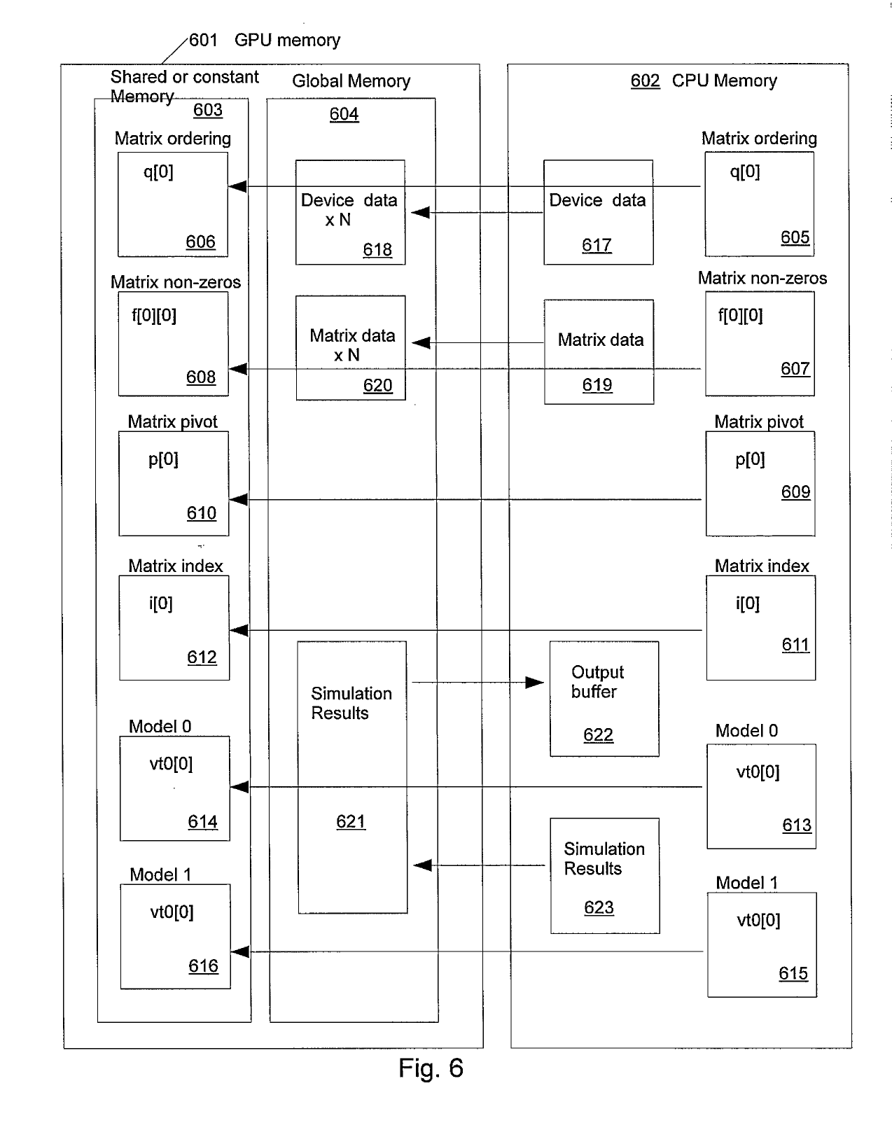

FIG. 6 shows the manner in which data structures, such as those shown in FIGS. 4 and 5 are transferred between CPU memory (e.g., CPU memory 602) and GPU memory 601, in accordance with one embodiment of the present invention. As shown in FIG. 6, read-only type data, such as ordering array 605, non-zero pattern array 607, pivoting array 609, sparse matrix index array 611, device model 613 (corresponding to device model 0) and device model 615 (corresponding to device model 1) are copied from CPU memory 602 to memory 603, which may be either the constant memory or the texture memory in GPU 601. As these data structures are common to all process threads, only one copy need to be provided in GPU memory 601. For data structures that are unique to each process thread (e.g., each duplicated circuit), a unique copy of each data structure is provided in global memory 604 for each process thread. Thus, N copies of device data 617 are provided in global memory 604, one for each process thread. Similarly, N copies of matrix data 619 are provided in global memory 604, one for each process thread.

Simulation is then performed in GPU 601. Some of the values from simulation results 621 in global memory 604 are copied to output buffer 622 in CPU memory 602 for further processing. In some embodiments, simulation tasks that cannot be handled by GPU 601, or not desired to be handled by GPU 601, may still be handled by CPU 602. Simulation data or results 623 in CPU memory 602 are the copied and combined with the simulation results 621 in GPU memory 604.

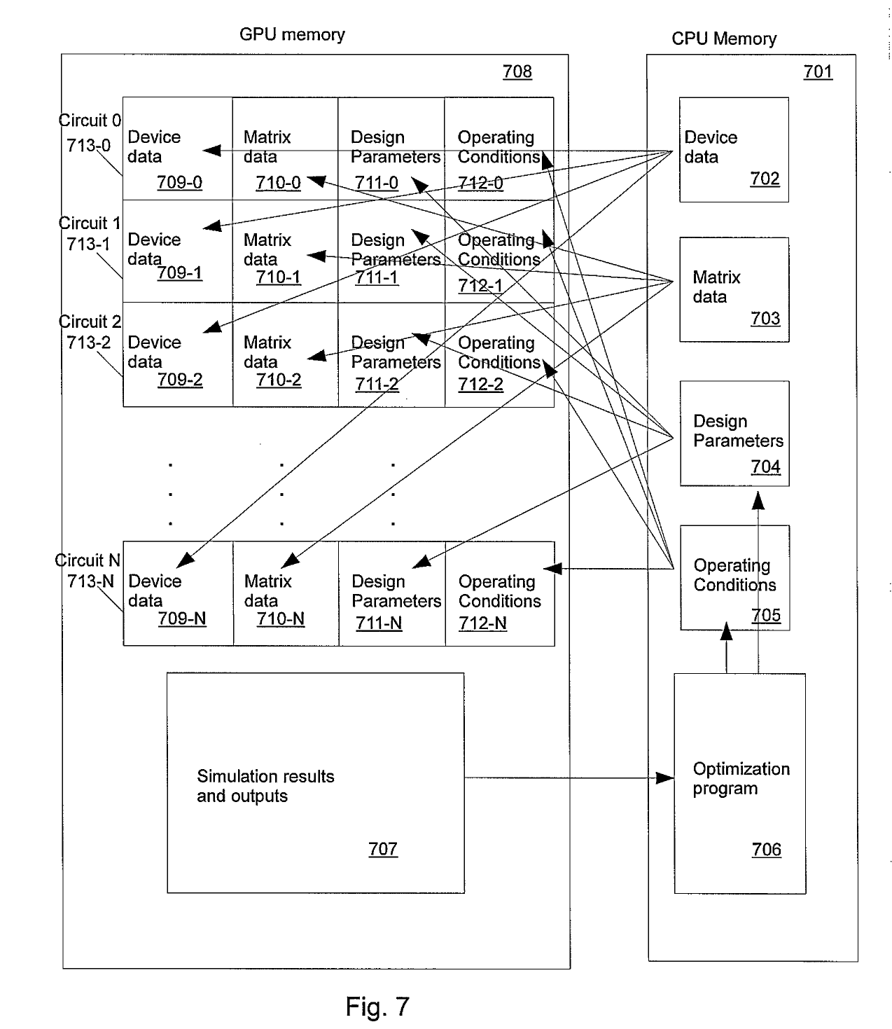

FIG. 7 shows a circuit optimization flow using a concurrent simulation system of the present invention. As shown in FIG. 7, initially, circuit data structures, such as the previously described device and matrix data, are generated in CPU memory 701 based on an input data netlist. Such initial circuit data structures are represented in FIG. 7 as device data 702, matrix data 703. Next, optimization program 706 creates design parameter values 704 and operating conditions 705 to be used with each duplicated circuit in each iteration. Circuit data structures 702 and 703 are duplicated in GPU memory 708 as device data 709 and matrix data 710, for each of duplicated circuit 0, 1, . . . , N. In FIG. 7, GPU memory 708 represents the texture memory, the constant memory and the global memory discussed above.

Each duplicated circuit 0, . . . , N can have different design parameters (e.g., device sizes) and may operate under a different set of operating conditions (e.g., input values, output values, process corners, temperatures and voltages). Design parameter values 704 and operating conditions 705 in CPU memory 701 are then copied to GPU 708 as design parameter values 711 and operating conditions 712, for each of duplicated circuit 0, . . . , N.

In general, each duplicated circuit 0, 1, . . . , N share the same device data and matrix data, but are provided different design parameter values or operating conditions. Simulations of circuit 0, . . . , N are then performed in the GPU, providing simulation results 707, which are then copied to CPU memory 701.

Circuit optimization program 706 analyzes results 707 of CPU memory 701 and may determine new sets of design parameter values to be analyzed. The memory locations allocated in GPU memory 708 for the previous analysis may then be freed and reallocated for the next set of concurrent simulations. This process may be iterated multiple times until the design meets user-specified criteria or until the user-specified iteration limit is reached.

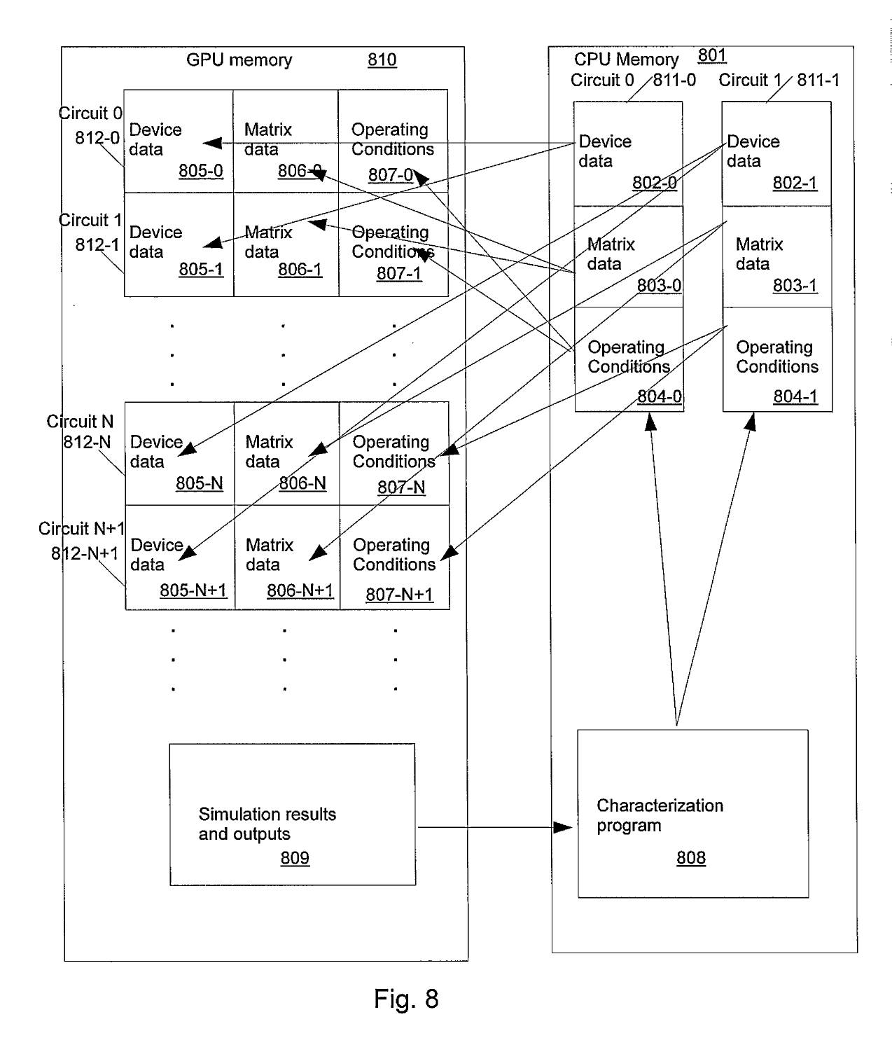

FIG. 8, shows a circuit characterization flow using a concurrent simulation system of the present invention. As shown in FIG. 8, initially, circuit data structures, such as the previously described device and matrix data, are generated in CPU memory 801 based on input data regarding the IP (intellectual property) library or function blocks to be characterized. These IP or functional blocks are represented by circuit 0 and circuit 1. The device and matrix data are represented as device data 802 and matrix data 803 in each circuit. More than one IP or block can be characterized at the same time or iteration. Characterization program 808 selects the circuits to be characterized in each iteration and determines operating conditions 804 for each circuit.

Next, device data 802 and matrix data 803 for the first selected circuit (e.g., circuit 0 of CPU memory 801) are copied to GPU memory 810 as device data 805 and matrix data 806, for each of duplicated circuits 0, . . . , N−1. Duplicated circuit 0, . . . , N−1 are copies of the circuit by characterization program 808. Each duplicated circuit 0, 1, . . . or N−1 operates under a different set of operating conditions 807 (e.g., input and output conditions, process corners, temperatures and voltages), which are copied from operating conditions 804 of the selected circuit in CPU memory 801.

As more than one IP or function block can be characterized in the same iteration, characterization program 808 may select a second circuit (e.g., circuit 1 of CPU memory 801). The process of creating device data, matrix data and operating conditions in GPU 810 is repeated for this second selected circuit. In FIG. 8, circuit N represents the first duplicated circuit in GPU memory 810 of circuit 1 in CPU memory 801.

Concurrent simulations are then performed in the GPU. Simulation results 809 are then copied to CPU memory 801. Circuit characterization program 808 may determine additional IP or circuit blocks to be characterized. The data structures created in GPU memory 810 may then be freed up to allow creation of the new data structures for the IP or circuit blocks to be next characterized. The characterization process is reiterated until all IP or blocks are characterized. Circuit characterization program 808 analyzes the results returned from the GPU and provides as output the characterized timing, power and other information regarding the characterized IP library or function blocks.

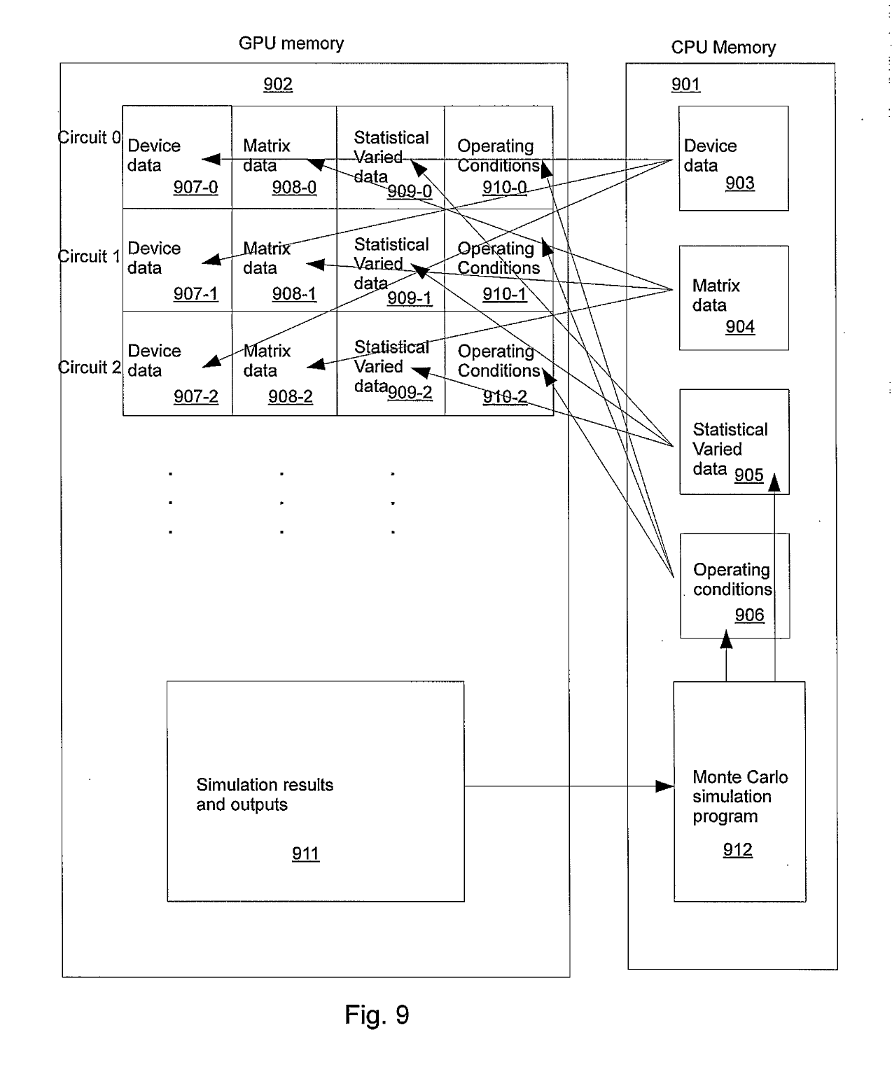

FIG. 9 shows a Monte Carlo simulation flow using a concurrent simulation system of the present invention. As shown in FIG. 9, initially, circuit data structures, such as the previously described device and matrix data, are generated in CPU memory 901 based on an input netlist. Such initial circuit data structures are represented in FIG. 9 as device data 903, matrix data 904. Mote Carlo simulation program 912 generates all statistically varied data 905 for all the random variables in the device models or user specification for every Monte Carlo simulation iteration. Generation of statistically varied data 905 may be performed using either the CPU or the GPU. Each Monte Carlo simulation is carried out using a unique set of statistically varied data 905 for all random variables.

Next, Monte Carlo simulation program 912 determines the number of Monte Carlo simulation iterations desired in each step. Circuit data structures (e.g., device data 903 and matrix data 904) are duplicated in GPU memory 902 for each of circuit 0, . . . , N, where N+1 is the number of simulation iterations. Each duplicated circuit data structure includes a set of statistically varied device and model parameter values. Each duplicated circuit 0, . . . , N may operate under a different set of operating conditions (e.g., input values, output values, process corners, temperatures and voltages). Operating conditions 906 in CPU memory 901 are then copied to GPU 902 as operating conditions 910, for each of duplicated circuit 0, . . . , N.

Simulations of duplicated circuit 0, . . . , N are then performed in the GPU, providing simulation results 911, which are then copied to CPU memory 901. Monte Carlo simulation program 912 analyzes the results and output the statistical values of the analysis results. Monte Carlo simulation program 912 may then determine a new set of Monte Carlo simulation iterations to be performed. The memory locations allocated in GPU memory 902 for the previous analysis may then be freed and reallocated for the next set of concurrent simulations. This process may be iterated multiple times until a set of predetermined statistical acceptance criteria are satisfied or the number of Monte Carlo iterations is reached.

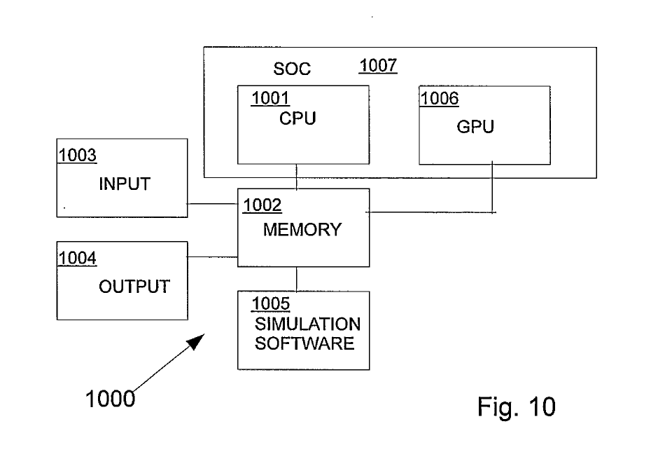

FIG. 10 is a block diagram illustrating an alternative embodiment of the concurrent simulation system 1000 which includes SOC 1007, global memory 1002, input subsystem 1003, output subsystem 1004, and simulation software 1005 (loaded into global memory 1002 during execution). SOC 1007 further includes CPU (or general purpose processor) 1001 and GPU (or graphic processing unit) 1006. In SOC 1007, global memory 1002 is accessible by both CPU 1001 and GPU 1006. Concurrent simulation system 1000 is controlled by simulation software 1005, which include executable codes for both CPU 1001 and GPU 1006. Simulation software 1005 may carry out the concurrent simulation algorithms described above. When a user specifies a circuit to be simulated, thus executing simulation software 1005 on processor 1001, the results in simulation data is generated in memory 1002. The simulation data is then set up (e.g., duplicated) and modified in memory 1002 by GPU 1006 based on the specific application and user specifications. In one embodiment, after simulation, simulation software 1005 provides the results for analysis by CPU 1001. The analyzed results and reports generated by the analysis are sent to output subsystem 1004 for display or to be otherwise reported.

The detailed description herein is provided to illustrate specific embodiments of the present invention and is not intended to be limiting. Numerous modifications and variations within the scope of the invention are possible. The present invention is set forth in the following claims.

We claim:

1. A concurrent simulation system for analog and mixed mode circuits, comprising:
a general purpose processor;
a main memory storing simulation software and data;
an input device;
an output device; and
a graphic processing unit including locally accessible memory, wherein the simulation software is executable by the general purpose processor to control the input device, the output device and to program operations in the graphic processing unit for circuit simulation.

2. A concurrent simulation system as in claim 1, wherein the graphic processing unit comprises a plurality of processors capable of executing in parallel.

3. A concurrent simulation system as in claim 2, wherein the processors in the graphic processing unit cooperate to execute a plurality of process threads.

4. A concurrent simulation system as in claim 3, wherein process threads simulate circuits having the same circuit structure under different operating conditions.

5. A concurrent simulation system as in claim 3, wherein process threads simulate circuits having the same circuit structure under different device parameter values.

6. A concurrent simulation system as in claim 3, wherein fixed values relevant to the circuit simulation are provided in the locally accessible memory and wherein the process threads accesses the fixed values simultaneously.

7. A concurrent simulation system as in claim 6, wherein the fixed values comprises device model parameters.

8. A concurrent simulation system as in claim 6, wherein the circuit simulation includes solving matrix equations, wherein the fixed values comprise values relevant to fixed ordering, predefined non-zero patterns, and fixed pivoting information.

9. A concurrent simulation system as in claim 3, wherein a set of data evaluated in the circuit simulation by the process threads are provided in the locally accessible memory at locations of consecutive addresses and wherein the process threads accesses the set of data simultaneously.

10. A concurrent simulation system as in claim 3, wherein the process threads are designed to take advantage of memory coalescing in the locally accessible memory.

11. A concurrent simulation system as in claim 3, wherein the simulation software programs the process threads to perform one of: circuit characterization, circuit optimization, and Monte Carlo simulations.

12. A concurrent simulation system as in claim 3, wherein the locally accessible memory comprises a global memory accessible to all process threads and a shared memory accessible by a subset but not all of the process threads.

13. A concurrent simulation system as in claim 1, further comprising one or more additional graphic processing units.

14. A concurrent simulation system as in claim 1, further comprising an interconnection bus connecting the general purpose processor to the graphic processing unit.

15. A concurrent simulation system as in claim 1, wherein results of circuit simulation in the graphic processing unit are transferred from the graphic processing unit to the main memory, and wherein the general purpose processor analyzes the results and report the results via the output device;

16. A concurrent simulation system as in claim 1, wherein circuit simulation operations are carried out in both the general purpose processor and the graphic processing unit.

17. A concurrent simulation system as in claim 1, wherein a netlist representing a circuit to be simulated is received from the input device.

18. A concurrent simulation system as in claim 17, wherein the simulation software provides the graphic processing unit data structures representing the netlist, device models, and operating conditions for each simulation to be performed in the graphic processing unit.

19. A concurrent simulation system as in claim 1, wherein the simulation software programs the graphic processing unit to perform the operations of device model evaluation and solving for matrix solution,

20. A simulation system according to claim 1, formulate device model equation and matrix equation in a special data structure to achieve maximum speed up with GPU for simulation applications which require repetitive simulation of the same or similar circuits under the same or different operating conditions.

21. A concurrent simulation system as in claim 1, wherein the simulation software allocate sequential computation tasks to the general purpose processor and repeated or computation intensive tasks to the graphic processing unit.

22. A method for simulating analog and mixed signal circuits in a concurrent fashion in a concurrent simulation system including a general purpose processor and a graphic processing unit, comprising:
(a) receiving as input a circuit netlist representing an input circuit, device models, operating conditions, and circuit;
(b) building circuit simulation data structures for the input circuit in a memory accessible by the general purpose processor;
(c) obtaining in the general purpose processor a pre-solved matrix solution to obtain matrix ordering, non-zero patterns and pivoting information;
(d) duplicating the circuit simulation data structures in a local memory of the graphic processing unit;
(e) performing circuit simulation in the graphic processing unit to provide simulation results in the local memory;
(g) transferring the simulation results output values from the local memory of the graphic processing unit to the memory accessible by the general purpose processor; and
(h) analyzing the transferred simulation results in the general purpose processor.

23. A method as in claim 22, wherein when performing the circuit simulation comprises dividing the circuit simulation into smaller blocks and executing the smaller blocks using successive groups of process threads.

24. A method as in claim 22, wherein for a circuit optimization application, building circuit simulation data structures comprises providing one or more sets of design parameter values and one or more sets of operating conditions;

25. A method as in claim 22, wherein for Monte Carlo simulations, further comprising generating all statistically varied values for all random variables and providing in the circuit simulation data structures one or more sets of random variable values and one or more sets of operating conditions.

26. A method as in claim 22, wherein for circuit characterization, providing in the circuit simulation data structures one or more sets of input or output conditions, one or more temperatures, and one or more process corners.
